(19) United States
(12) Patent Application Publication
(10) Pub. No.: US 2015/0290776 A1
(43) Pub. Date: Oct. 15, 2015

(54) BALANCING OR MEASURING DEVICE

(71) Applicant: FRANZ HAIMER MASCHINENBAU KG, Igenhausen (DE)

(72) Inventor: Franz Haimer, Igenhausen (DE)

(73) Assignee: FRANZ HAIMER MASCHINENBAU KG, Igenhausen (DE)

(21) Appl. No.: 14/437,854

(22) PCT Filed: Oct. 17, 2013
(86) PCT No.: PCT/EP2013/071680

§ 371 Date: Apr. 23, 2015

(30) Foreign Application Priority Data
Oct. 25, 2012 (DE) 10 2012 110 186.8

(51) Int. Cl. B25B 5/06; G01D 11/02

(52) U.S. Cl. CPC B25B 5/065; G01D 11/02

(57) ABSTRACT

The invention relates to a balancing or measuring device which comprises a base body (2) which can be rotated about a central axis (1) and which is used to receive a component (5) which is to be balanced or measured, and at least one centering element (6). A radial bias of the centering element (6) can be modified by a pressurized liquid for flexibly using the balancing or measuring device.

The invention relates to a balancing or measuring device according to the preamble of Claim 1 and to a balancing or measuring machine with such a balancing or measuring device.

The balancing or measuring machines used for the balancing or measuring of tools, tool holders, or other rotating components typically include a base body that can be rotated about a central axis by means of a drive motor and includes a receptacle constructed, e.g., as a central receptacle opening for the component to be balanced or measured. By means of a suitable clamping device, the component to be balanced or measured can be clamped in or on the base body. To produce precise centering of the component on the rotating base body, both the receptacle on the base body and also the corresponding mating piece on the component to be balanced or measured must be produced with extreme precision. However, because the balancing or measuring devices should also be used for components produced with different degrees of precision and because the components to be balanced or measured cannot always be produced adapted exactly to the precision of the receptacle of the base body, e.g., ball linings are used as additional centering elements. These centering elements, however, are susceptible to wear and can leave undesired pressure marks or tracks on the component to be balanced or measured. In addition, such centering elements have a predefined radial biasing force that cannot be modified without additional elements.

A balancing device for a tool holder according to the class is known from DE 199 61 451. This contains a base body that can be rotated about a central axis with a receptacle for a coupling shaft of a component to be balanced or measured and centering elements arranged in the base body with support areas that are elastically resilient in the radial direction and project relative to the receptacle for centering the coupling shaft.

The task of the invention is to create a balancing or measuring device of the type named above and a balancing or measuring machine that enable flexible use

This task is achieved by a balancing or measuring device with the features of Claim 1 and by a balancing or measuring machine with the features of Claim 16. Preferred improvements and advantageous embodiments of the invention are the subject matter of the dependent claims.

The balancing and measuring device according to the invention distinguishes itself in that the radial bias of the at least one centering element can be modified by a pressurized liquid. In this way, the biasing force of the centering element can be adapted to the respective requirements. The pressurized liquid can be, e.g., pressurized air, hydraulic fluid, or some other gaseous or liquid pressurized fluid, by means of which a radial load is applied to the centering element.

Advantageously, a pressure chamber that can be charged with the pressurized liquid is limited between the base body and the at least one pressure chamber. By feeding the pressurized liquid to the pressure chamber, the bias of the centering element can be increased.

The base body can have, in one possible construction, a receptacle constructed as a receptacle opening for a coupling shaft of the component to be balanced or measured. The base body, however, can also have the shape of a pin on whose outer side the centering element is attached.

In one advantageous construction, the at least one centering element can be constructed as a separate component and can be inserted into an annular recess on the top side of the base body. The centering element can be constructed, e.g., as a centering ring with a flexible inner support area and two support legs supported on an inner wall of the recess. The pressure chamber can be limited by the inner wall of the recess and the inner sides of the flexible support area and the two support legs. The centering element, however, could also be constructed in one piece with the base body. In this way, the production and assembly costs can be reduced.

The balancing or measuring device described above is part of a balancing or measuring machine in which the component to be balanced or measured is pulled into a receptacle opening of the base body rotating about the rotational axis and held there by means of the coupling shaft with the help of a known clamping device.

Additional special features and advantages of the invention are given in the following description of preferred embodiments with reference to the drawing. Shown are:

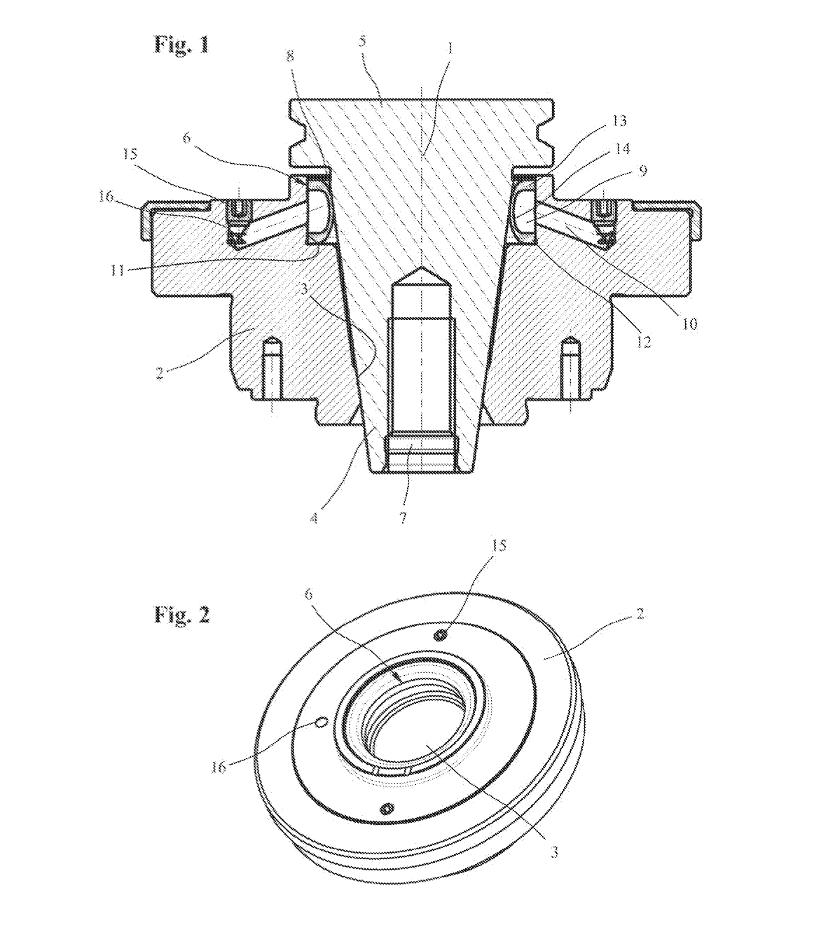

FIG. 1 an embodiment of a balancing or measuring device in a cross section and

FIG. 2 a balancing or measuring device in a perspective view.

FIGS. 1 and 2 show a balancing or measuring device with a base body 2 that can be rotated about a central axis 1 by a drive and contains a receptacle 3 formed as a conical receptacle opening for a shaft 4 here with a conical shape for a component 5 to be balanced or measured. The component 5 can be, e.g., a tool holder, a tool, or some other component to be balanced or measured. In the base body 2 there is an annular centering element 6 for concentric centering of the component 5 in the receptacle 3 of the base body 2. The base body 2 and the centering element 6 are parts of a balancing or measuring device that is used in a balancing or measuring machine for the balancing or measuring of rotating components.

In the shown construction, the base body 2 is constructed as an adapter for the fastening of a machine spindle. In this way, the balancing or measuring device can be adapted in a relatively quick and simple way to different types of coupling shafts on tools or tool holders. The base body 2, however, could also be, e.g., the machine spindle itself, driven by a motor.

In the embodiment shown in FIG. 1, the receptacle 3 is constructed as a conical receptacle opening for receiving a conical shaft 4 of the component 5 constructed as a coupling shaft. The receptacle 3, however, could also be constructed as a cylindrical receptacle opening for a cylindrical shaft or in some other suitable way. The component 5 contains, at the lower end of the shaft 4, a threaded hole 7 that is used for screwing in a clamping pin of a clamping device that is itself known and therefore not shown. By means of this clamping device, the component 5 with the shaft 4 can be pulled into the receptacle 3 of the base body 2 and clamped tightly there.

In the shown construction, the centering element 6 is inserted as a separate centering ring into an annular recess 8 on the top side of the base body 2. The centering element 6, however, could also be constructed in one piece with the base body 2. Between the centering element 6 and the base body 2, a pressure chamber 9 is defined that can be charged with pressurized air or some other pressurized liquid. By modifying the pressure within the pressure chamber 9, the radial bias of the centering element 6 can be modified. By feeding pressurized liquid into the pressure chamber 9, e.g., the centering element 6 can be pressed radially inward and thus the bias of the centering element 6 can be increased. For feeding the pressurized liquid to the pressure chamber 9, one or more holes 10 opening into the pressure chamber 9 are provided in the base body 2.

The annular centering element 6 has, in the construction of FIG. 1, a C-shaped cross section with two support legs 12 and 13 facing an inner wall 11 of the recess 8 and a flexible, and here slightly bent inner support area 14 facing the coupling shaft 4 between the two support legs 12 and 13. The annular centering element 6 is supported on the base body 2 by means of the two parallel support legs 12 and 13 that are arranged at a distance from each other.

In the shown construction, both support legs 12 and 13 contact the inner wall 11 of the annular recess 8. The slightly bent support area 14 on the inside of the annular centering element 6 is elastically resilient in the radial direction and projects inward relative to the receptacle 3 when the component 5 is not inserted. In this way, the center element 6 can generate a radial bias for centering the coupling shaft 4 within the receptacle 3 constructed as a conical receptacle opening for its insertion by means of the inner, flexible, and elastically resilient support area 14, also without pressurizing the pressure chamber 9. In this construction, the pressure chamber 9 is limited by the inner wall 11 and the inner sides of the bent support area 14 and the two support legs 12 and 13. If the pressure within the pressure chamber 9 running radially around the annular centering element 6 is increased by feeding a pressurized liquid, the bent support area 14 can be pressed radially inward and therefore the bias of the centering element can be increased. The feeding of the pressurized liquid to the pressure chamber 9 can take place by means of one or more holes 10.

The pressurizing can take place by means of one or more pistons that are pressed into a hole and therefore force the pressurized liquid from the hole into the pressure chamber 9. The piston can have the shape of threaded pins 15 that are screwed into a threaded hole 16. In one preferred embodiment, the threaded pins 15 project from the base body 2 in the unfastened position and are thus used as visual indicators that the pressure chamber 9 is not pressurized. In the clamped position, the threaded pins 15 align flush with the surface of the base body 2 and thus indicate the clamped position.

In another not-shown embodiment, the pressurizing of the pressure chamber 9 is caused automatically by means of a clamping device. For this purpose, the clamping device actuates a piston that presses the pressurized liquid into the pressure chamber. At the same time, the clamping device can be used to pull the component in the direction of the central axis into the receptacle 3. The hole in which the piston moves can have pressure-relief holes that are arranged such that the pressure builds up only at the end of the clamping motion. In this way, the component can be first pulled into the receptacle 3 without significant friction. Only when the axial movement has nearly stopped is the pressure chamber 9 charged with pressure.

In the shown construction, only one centering element 6 is arranged in the base body 2. However, multiple centering elements 6 arranged one above the other could also be provided.

It is understood that the invention is not restricted to components with shaft-like clamping sections. The base body 6 could analogously also have the shape of a pin on whose outer side the centering element 6 is mounted. In this case, when the pressure chamber 9 is pressurized, the centering element 6 is pressed radially outward and thus can clamp a component 5 that has a corresponding hole.

1. Balancing or measuring device that contains a base body that can be rotated about a central axis with a receptacle for a coupling shaft of a component to be balanced or measured and at least one centering element that is arranged in the base body with a support area that is elastically resilient in the radial direction and projects relative to the receptacle for centering the coupling shaft, wherein the radial bias of the centering element can be modified by a pressurized liquid and the at least one centering element is inserted into an annular recess on the top side of the base body.

2. Balancing or measuring device according to claim 1, wherein a pressure chamber that can be pressurized with the pressurized liquid is defined between the at least one centering element and the base body.

3. Balancing or measuring device according to claim 1, wherein the centering element has a C-shaped cross section.

4. Balancing or measuring device according to claim 1, wherein the at least one centering element is constructed in one piece with the base body.

5. Balancing or measuring device according to claim 1, wherein one or more holes or passages opening into the pressure chamber are arranged in the base body for feeding the pressurized liquid to the pressure chamber.

6. Balancing or measuring device according to claim 5, wherein the pressurized liquid is pressed by one or more pistons into the holes or passages.

7. Balancing or measuring device according to claim 6, wherein the pistons are constructed in the shape of threaded pins that are screwed into a threaded hole.

8. Balancing or measuring device according to claim 7, wherein the threaded pins project from the base body in an unfastened position and align flush with the base body in a clamped position.

9. Balancing or measuring device according to claim 6, wherein the hole in which the piston moves has pressure-relief holes that are arranged such that the pressure builds up only at the end of the clamping motion.

10. (canceled)

11. Balancing or measuring device according to claim 1, wherein the at least one centering element is constructed as a centering ring with a flexible inner support area and two support legs pointing toward an inner wall of the recess.

12. Balancing or measuring device according to claim 11, wherein the centering element is supported by the support legs on the inner wall of the recess.

13. Balancing or measuring device according to claim 11, wherein the pressure chamber is defined by the inner wall of the recess and the inner sides of the flexible support area and the two support legs.

14. Balancing or measuring device according to claim 1, wherein the support area projects inward relative to the receptacle.

15. Balancing or measuring device according to claim 1, wherein the base body is constructed as a pin on whose outer side the centering element is mounted.

16. Balancing or measuring machine with a balancing or measuring device according to claim 1.
